(19) United States
(12) Patent Application Publication
(10) Pub. No.: US 2010/0088826 A1
(43) Pub. Date: Apr. 15, 2010

(54) Compact tool kit

(76) Inventor: Larry Chen, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,649

(22) Filed: Oct. 10, 2008

(51) Int. Cl. B25F 1/04

(52) U.S. Cl. 7/138; 7/170

(57) ABSTRACT

A tool kit for bicycles includes a first body having a first space defined therein, a second body having a second space defined therein, and a link unit having a first end pivotably connected to a first end of the first body and a second end of the link unit pivotably connected to a first end of the second body. A plurality of tools are pivotably connected to a second end of the first body and a second end of the second body. The tools can be pivoted outward to fix the bicycle and the first and second bodies can be pivoted away from each other to form suitable grip portion for the rider.

### FIELD OF THE INVENTION

The present invention relates to a compact and foldable tool kit having multiple tools pivotably connected to two bodies thereof.

### BACKGROUND OF THE INVENTION

Bicycles are welcomed and popular by more and more people because bicycles do not pollute environment and are ideal transportation tools for short distance travel. Most of the cyclists are advised to carry a simple tool kit in case of unexpected situations happened to their bicycles. However, bicycles may have different types of problems such as chain dropping or flat tire, different problems need different tools which have to be carried conveniently to meet the needs for the riders.

FIGS. 9 and 10 show a conventional bicycle tool kit which includes a first body 71 and the second body 72 which is slidably connected to the first body 71. A connection member 73 connect the first and second bodies 71, 72 to each other. The second body 72 includes a protrusion slidably engaged with the groove in the first body 71. By sliding the second body 72 along the groove, the positioning member on the first body can be positioned in a recess in the second body 72 to set the relative position between the two bodies 71, 72. However, when the tool is pivoted outward and applies a torque to the bicycle's part, the two bodies 71, 72 cannot form a sufficient grip portion for the rider to easily output the torque.

Another conventional bicycle tool kit is disclosed in FIGS. 11 and 12, and includes two bodies 82 which are connected to sides of a connection board 81 which has a narrow end 83. Two recesses 84 are defined in two sides of the narrow end 83 and extend toward the other end, the wide end, of the connection board 81. A chain tool is connected to the wide end. Each body 82 includes a base board 85 and two side panels 86, and a pin 87 extend through the two side panels 86, tools are pivotably connected to the pin 87. The end remote from the tools of the base board 85 includes positioning slot 88 so as to receive the protrusion on the connection board 81. Again, there is no sufficient grip portion provided for the rider to hold and the connection between each part of the tool kit is not reliable and might be separated from each other in some situations.

The present invention intends to provide a compact and portable tool kit for bicycles and the tool kit includes two elongate bodies and a link unit is pivotably connected between two respective ends of the two bodies. Tools are pivotably received in spaces in the two bodies and can be pivoted outward when in use. The two bodies can be pivoted away from each other to form a suitable grip portion.

### SUMMARY OF THE INVENTION

The present invention relates to a tool kit for bicycles and the tool nit comprises a first body, a second body, and a link unit pivotably connected between the first and second bodies. The first body has a first space defined therein and the second body has a second space defined therein. Tools are pivotably connected to the pivotably connected to the first and second bodies and can be stored in the first and second spaces.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tool kit of the present invention;

FIG. 2 is an exploded view to show the tool kit of the present invention;

FIG. 3 is a perspective view to show the tool kit of the present invention, wherein the first and second bodies are pivoted away from each other;

FIG. 4 is an exploded view to show the first and second bodies and the tools of the present invention;

FIG. 5 shows the tools are pivoted outward from the second body while the first and second bodies are arranged side by side;

FIG. 6 is a perspective view to show the tool kit of the present invention, wherein the first and second bodies are pivoted away from each other;

FIG. 7 shows that the rider holds the first and second bodies as the grip portion to use the tool kit;

FIG. 8 shows that the first and second bodies are pivoted and the link unit is perpendicular to the first and second bodies;

FIGS. 9 and 10 show a conventional tool kit for bicycles, and

FIGS. 11 and 12 show another conventional tool kit for bicycles.

### DETAILED DESCRIPTION OF THE PREFERRED EMBODIMENT

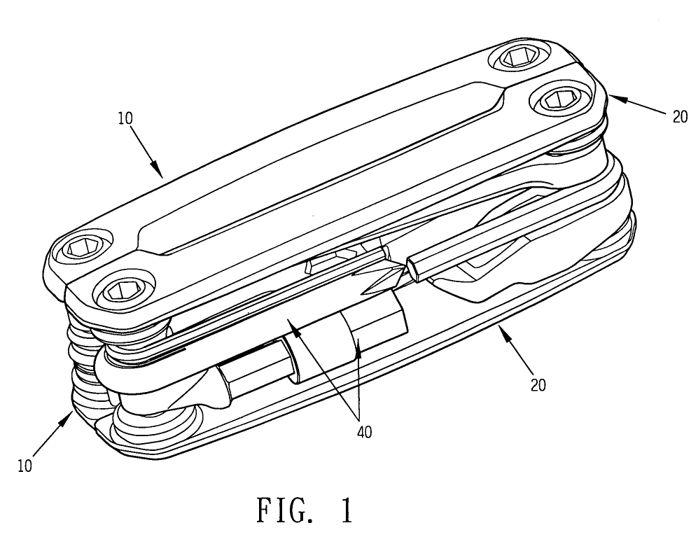

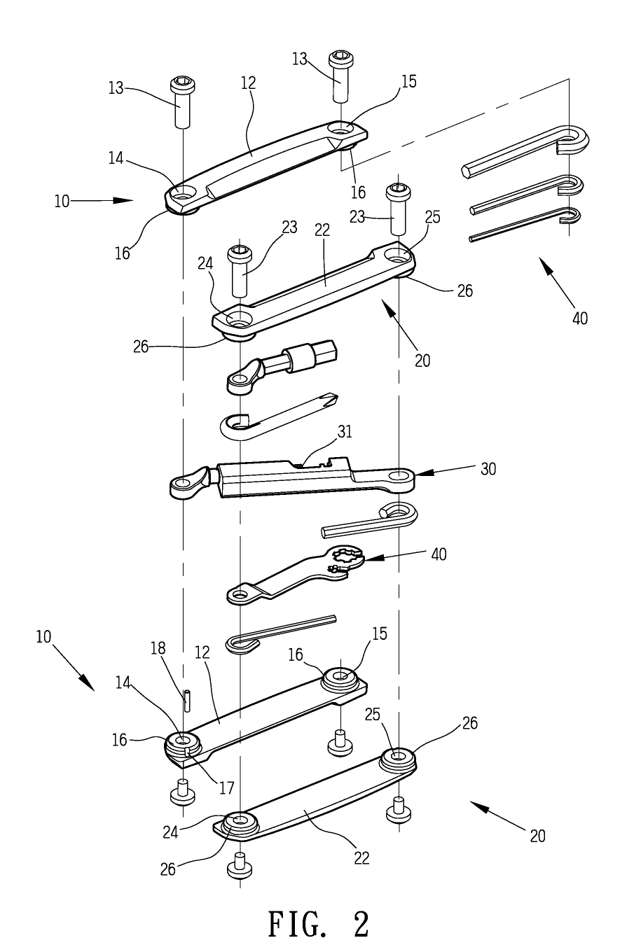

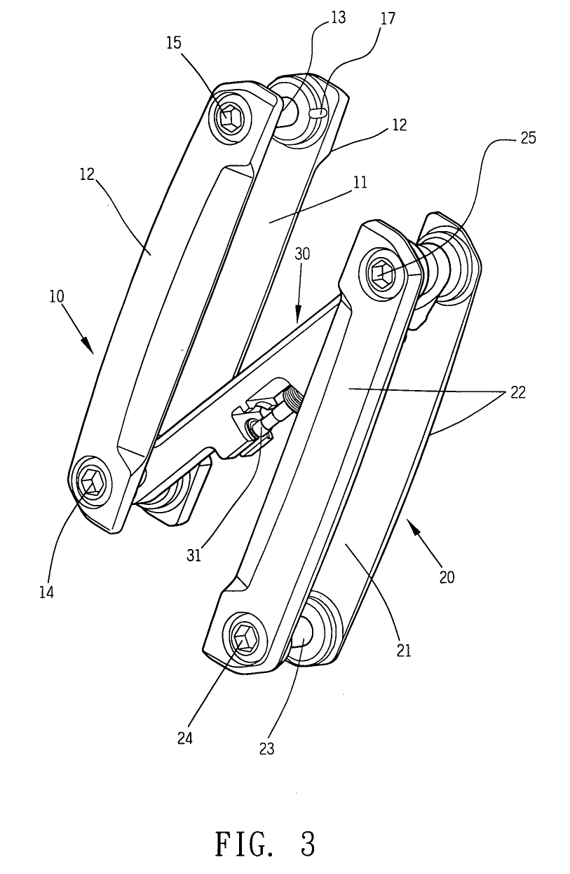

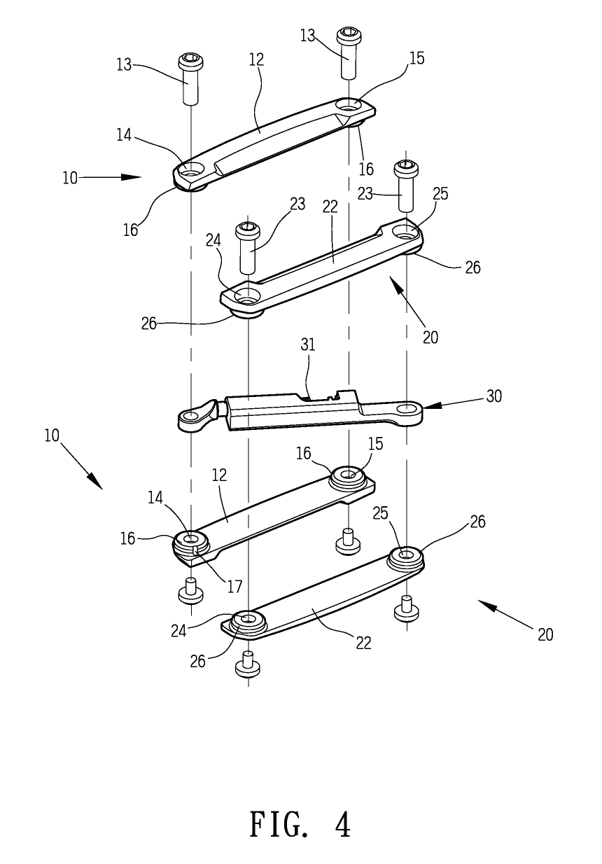

Referring to FIGS. 1 to 4, the tool kit for bicycles of the present invention comprises a first body 10 having a first space 11 defined therein, a second body 20 having a second space 21 defined therein and a link unit 30 pivotably connected between the first and second bodies 10, 20. The first body 10 includes two first plates 12 between which the first space 11 is defined. Two first pins 13 extend through two ends of the two first plates 12. Tools 40 are pivotably connected to the pin 13 on the second end of the first body 10. The second body 10 includes two second plates 22 between which the second space 21 is defined. Two second pins 23 extend through two ends of the two second plates 22. Tools 40 are pivotably connected to the pin 23 on the second end of the second body 20. The link unit 30 has a first end pivotably connected to a first end of the first body 10 and a second end of the link unit 30 is pivotably connected to a first end of the second body 20. The two respective first ends of the first and second bodies 10, 20 are located at two opposite ends of the link unit 30.

The tools 40 pivotably connected to the first body 10 and the second body 20 can be any desired shape such as a screw bit, a wrench head, a hexagonal rod or any known shaped tool bit.

The link unit 30 can be accommodated in the first and second spaces 11, 21 when the first and second bodies 10, 20 are arranged to folded status as shown in FIG. 1. In the folded status, two respective insides of the first and second bodies 10, 20 are in contact with each other.

Each of the first and second plates 12, 22 has a tubular portion 16/26 extending from an inside of each of the first and second ends thereof and each tubular portion 16/26 includes a notch 17/27 defined axially in an outer periphery thereof. A rod 18/28 is engaged with the notches 17/27. The rods 18, 28 can be a stop to prevent the tools 40 from overly rotated about the first and second pins 13, 23. The link unit 30 has a tool connected thereto which is used to re-match the bicycle chain with the sprockets (both not shown).

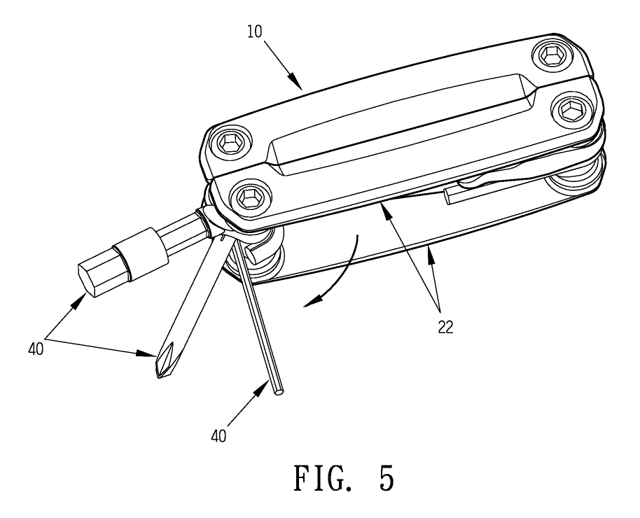

As shown in FIG. 5, when the first and second bodies 10, 20 are in a folded status, the two respective insides of the first and second bodies 10, 20 are in contact with each other. The tools 40 can be pivoted outward from the second space of the second body 20.

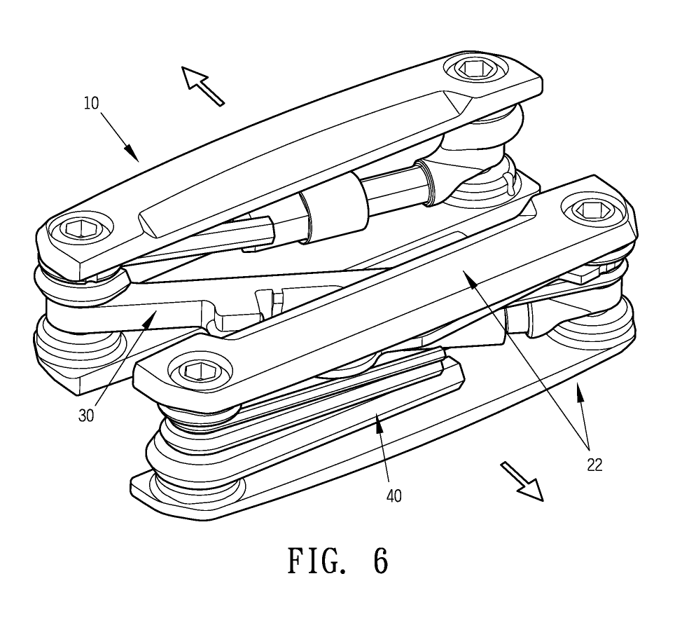

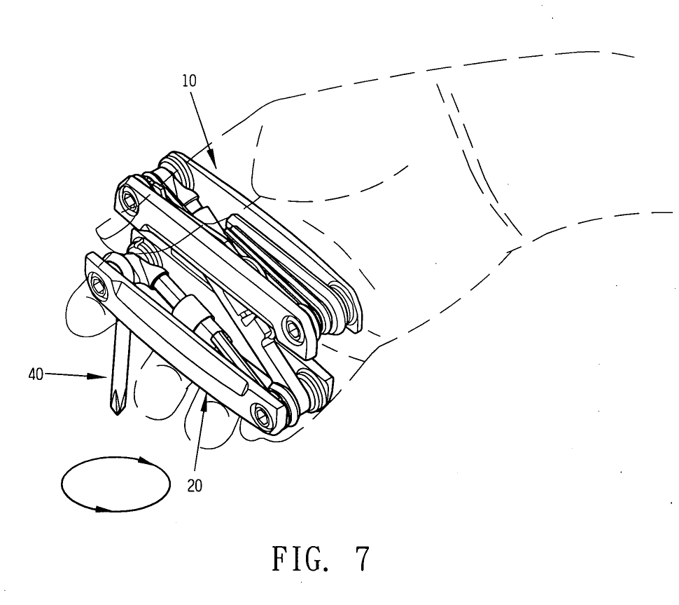

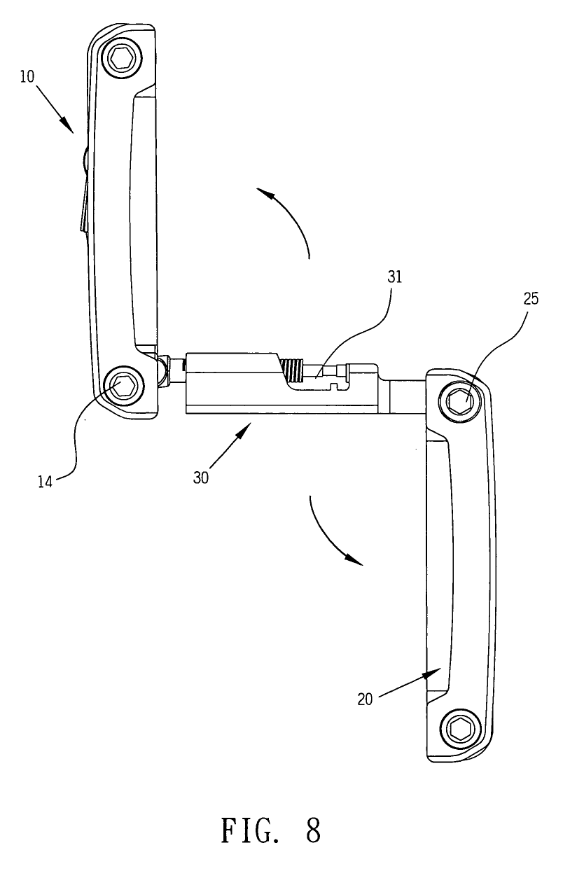

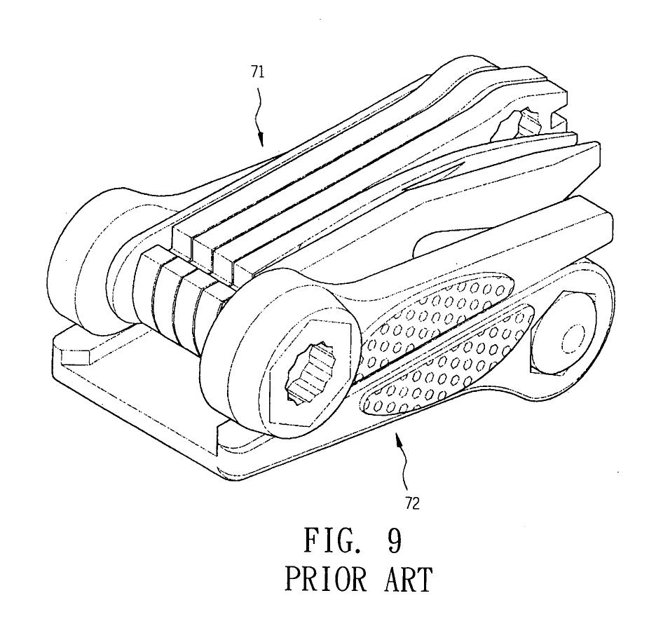

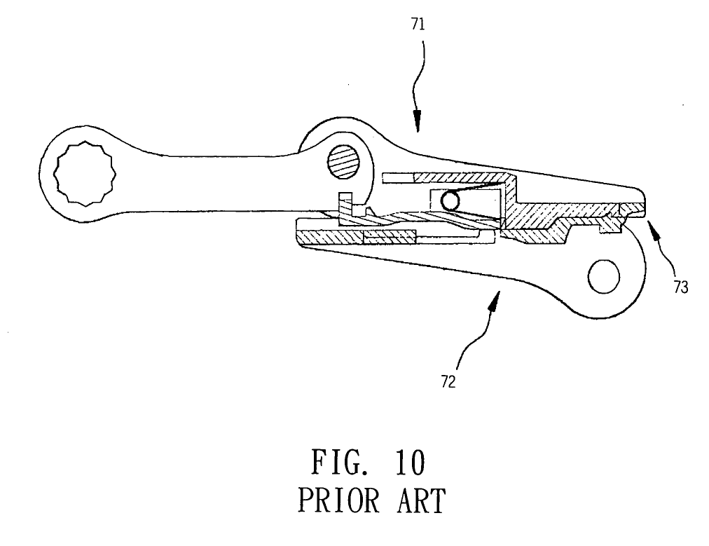

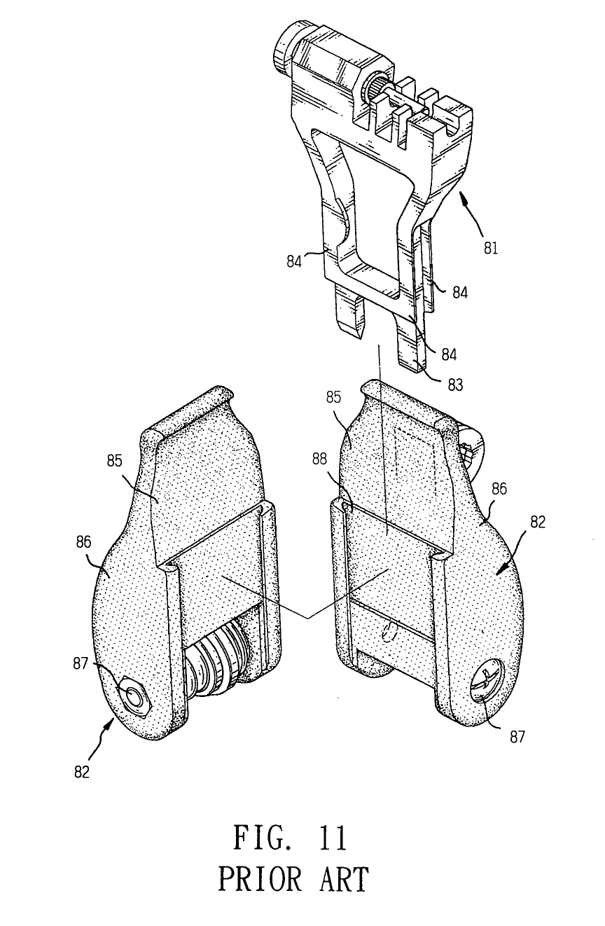

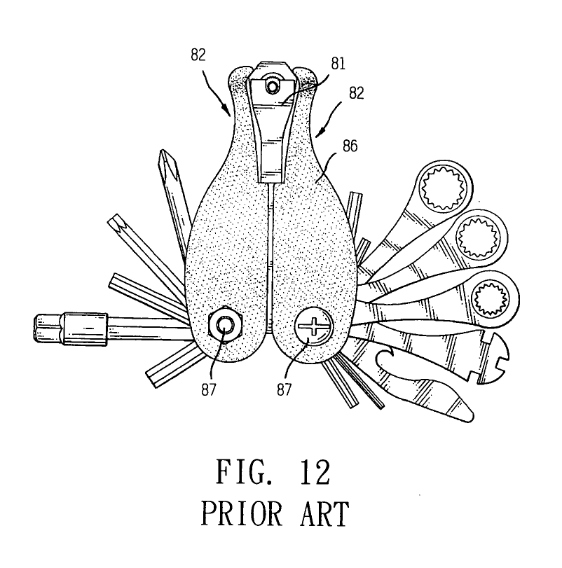

As shown in FIGS. 6 and 7, the first and second bodies 10, 20 can be pivoted away from each other and form a suitable grip portion so that the rider can hold the grip portion to operated the tool 40.

When using the tool kit to re-match the chain with the sprocket, the first and second bodies 10, 20 are pivoted and the link unit 30 is perpendicular to the first and second bodies 10, 20.

The tool kit of the present invention is compact and easily to carry, the different types of tools 40 are sufficient for the riders to face most of the situations to their bicycles. The rods 18, 28 restrict the tool from overly rotated and also help the tools 40 to be positioned at the best angle relative to the first and second bodies 10, 20.

While we have shown and described the embodiment in accordance with the present invention, it should be clear to those skilled in the art that further embodiments may be made without departing from the scope of the present invention.

1. A tool kit comprising:
a first body having a first space defined therein and opposing first and second ends;
a second body having a second space defined therein and opposing first and second ends;
a link unit having a first end pivotally connected to the first end of the first body and a second end of the link unit pivotally connected to the first end of the second body, the link unit including a first tool connected thereto intermediate the first and second ends thereof; and
a plurality of second tools pivotally connected to the second end of the first body and a plurality third tools pivotally connected to the second end of the second body.

2. The tool kit as claimed in claim 1, wherein the first body includes two first plates between which the first space is defined, two first pins extend through two ends of the two first plates, the second tools being pivotally connected to the pin on the second end of the first body.

3. The tool kit as claimed in claim 1, wherein the second body includes two second plates between which the second space is defined, two second pins extend through two ends of the two second plates, the third tools being pivotally connected to the pin on the second end of the second body.

4. The tool kit as claimed in claim 1, wherein the link unit is accommodated in the first and second spaces when the first and second bodies are arranged to folded status, two respective insides of the first and second bodies are in contact with each other.

5. The tool kit as claimed in claim 1, wherein each of the first and second plates has a tubular portion extending from an inside each of the first and second ends thereof and each tubular portion includes a notch defined axially in an outer periphery thereof, a rod is engaged with the notches.

6. (canceled)
